(19) United States
(12) Patent Application Publication
(10) Pub. No.: US 2016/0304993 A1
(43) Pub. Date: Oct. 20, 2016

(54) DUCTILE NICKEL-BASED AUSTENITIC ALLOY COATING AND METHOD OF MANUFACTURING

(71) Applicant: CAL POLY POMONA FOUNDATION, INC., Pomona, CA (US)

(72) Inventors: Vilupanur A. Ravi, Claremont, CA (US); George Lai, Del Mar, CA (US); Juan Carlos Nava, Chino, CA (US)

(21) Appl. No.: 14/932,271

(22) Filed: Nov. 4, 2015

Related U.S. Application Data
(60) Provisional application No. 62/075,773, filed on Nov. 5, 2014.

(51) Int. Cl. C22C 19/05; C25D 3/12; C25D 5/14; F02C 3/04; C25D 7/00; F01D 5/28; F01D 9/04; F01D 25/00; C22F 1/10; C25D 5/50

(52) U.S. Cl. CPC C22C 19/058; C22F 1/10; C25D 3/12; C25D 5/14; C25D 5/50; C25D 7/00; F01D 5/288; F01D 5/286; F01D 9/041; F01D 25/007; F01D 25/005; F02C 3/04; F05D 2300/175; F05D 2300/611; F05D 2300/17; F05D 2220/32; F05D 2240/30; F05D 2240/12; F05D 2240/35; F05D 2230/90

(57) ABSTRACT

The present application relates to systems and methods of producing ductile nickel-based austenitic alloy coatings. The methods may include using low levels of aluminum to form protective coatings, while retaining ductility. The method can include preselecting a desired thickness of coating to maximize the desired level of aluminum and ductility.

### INCORPORATION BY REFERENCE TO ANY PRIORITY APPLICATIONS

This application claims priority under 35 U.S.C. §119(e) to U.S. Provisional Patent Application No. 62/075,773, filed Nov. 5, 2014. Any and all applications for which a domestic priority claim is identified in the Application Data Sheet as filed with the present application are hereby incorporated by reference under 37 C.F.R. §1.57.

### BACKGROUND

Gas turbines can be used in a variety of industries, including 1) as jet engines for airplanes, 2) in utility power plants for generating electricity, 3) on naval ships and vessels for power and propulsion, and 4) in the oil and gas industry for electrical generation onshore and offshore.

A gas turbine consists of three major sections: the compressor, the combustor, and the turbine section. In operation, the compressor takes air in, and compresses the air to high pressures. The compressed air is then mixed with fuel in the combustor for combustion to generate high-velocity, hot-combustion gas. This hot combustion gas is expanded in the turbine section, where it can be used to generate power, or a large thrust when used in jet engines.

Components of the turbine section, such as the blades and vanes, are exposed to a high-temperature, high-velocity, combustion gas stream exiting from the combustor, and operate under highly cyclic stresses. Components of the turbine section include the blades and vanes. Modern turbine blades and vanes are mostly fabricated from Ni-base superalloys strengthened primarily by gamma prime (Ni₃Al) precipitates and refractory elements such as molybdenum, tungsten, tantalum, hafnium, molybdenum, and niobium. However, the Ni-based superalloys which meet the high-temperature strength requirements are susceptible to oxidation and other types of high-temperature corrosion at these high temperatures, particularly under the cyclical stress inherent in high-temperature, high-velocity gas turbines.

To protect against oxidation and other types of high-temperature corrosion, turbine blades and vanes are often covered by a coating. Coatings currently available, however, are thin and often become brittle during operation, thus making these coatings susceptible to cracking under cyclic conditions. Once a crack develops in the coating, the crack can readily propagate into the substrate superalloy, leading to fracturing of turbine blades or vanes. Such degradation of the turbine blades or vanes can result in premature failure of the gas turbine. In power plants, this failure can lead to costly downtime for repair or replace of the turbine components; for airplanes, the failure can lead to engine failure, which can potentially result in a plane crash.

Accordingly, there is a strong need to develop more ductile and crack-resistant coatings in order to provide a longer service life and more durable, reliable performance in protecting substrate superalloy blades and vanes for use in gas turbines,

### SUMMARY

Certain embodiments disclosed herein contemplate a gas turbine comprising at least two distinct parts. These parts can include a combustor and a turbine section. The combustor may be comprised of combustion chambers. The combustion chambers can be protected by a coating of 15-25% Cr, 4-8% Al, and 0.01-0.1% Y weight percent. The remaining composition of the coating can be Ni. The turbine section may be comprised of at least three stages, while each stage of the turbine can be comprised of at least two or more turbine components, including blades or vanes, or blades and vanes. The first stage of the turbine may be positioned closest to the combustor. Components comprising the first section of the turbine may be a superalloy substrate. The components can be protected by a coating comprised of about 15-25% Cr, 4-8% Al, and 0.01-0.1% Y weight percent. The remaining composition of the coating can be Ni.

The second stage of the turbine can be located downstream of the first section, and may be comprised of two or more turbine components, including blades or vanes, or blades and vanes. The components may be a superalloy substrate. The components can be protected by a coating comprised of about 20-30% Cr, 3-6% Al, and 0.01-0.1% Y, weight percent. The remaining composition of the coating can be Ni.

The third stage of the turbine can be located downstream of both the first and second sections of the turbine. The third stage can be comprised of two or more turbine components, including blades or vanes, or blades and vanes. Components comprising the third stage may be a superalloy substrate. The components can be protected by a coating comprised of about 30-45% Cr, weight percent. The remaining composition of the coating can be Ni.

Some embodiments of the disclosure may further have the components comprising the first stage subjected to temperatures of about 950° C. or higher. Some embodiments of the disclosure may further have the components comprising the second stage subjected to temperatures of about 800-950° C. Some embodiments of the disclosure may further have the components comprising the third stage subjected to a temperature regime of about 600-800° C.

Some embodiments of the disclosure may further have at least one component of each stage protected by a coating of about 300-500 μm in thickness. Some embodiments of the disclosure may further have at least one component of each stage protected by a coating of up to about 500 μm in thickness. Some embodiments of the disclosure may further have at least one component of each stage protected by a coating of about 500 μm in thickness or thicker.

Some embodiments of the disclosure provide a method for coating one or more components of a gas turbine. Components include any combination of blades, vanes, or combustion chambers. These components may be a superalloy substrate. The coating can be adhered to the component by first applying a segment which can be comprised of an amount of Ni, an amount of Cr, an amount of Al, and an amount of Y. A second segment may be adhered to the first segment. The second segment can be comprised of an amount of Ni, an amount of Cr, an amount of Al, and an amount of Y. Additional segments can be added until a desired thickness of total segments is achieved. Once the desired thickness is achieved, the segments may be subjected to a homogenization treatment. The homogenization treatment can create a single coating on the superalloy substrate of uniform concentrations of the elements contained in the segments adhered to the superalloy substrate.

Some embodiments of the disclosure may further have the first segment created by applying a nickel layer to the superalloy substrate, then applying the Cr, Al, and Y as a diffusion layer to the first nickel layer. Once the diffusion layer has been added to the first nickel layer, the first nickel layer and the diffusion layer may form the first segment on the superalloy substrate.

Some embodiments of the disclosure may further apply a second segment to the first segment, where the first segment may have been created by applying a nickel layer to the substrate, then applying a diffusion layer to the nickel layer. The second segment can be created by first applying nickel to the first segment, then applying the Cr, Al, and Y as a diffusion layer to the second nickel layer. The second nickel layer and second diffusion layer may form a second segment on the first segment.

Some embodiments of the disclosure may further repeat application of additional segments until a desired thickness of total segments is achieved. Once the desired thickness is achieved, all segments may be subjected to a homogenization treatment to produce a single coating on the superalloy substrate with uniform concentrations of the elements contained in the segments.

Some embodiments of the disclosure may further have the first segment, or second segment be about 100 μm in thickness. Some embodiments of the disclosure may further create a coating of about 300-500 μm in thickness after all layers have been subjected to a homogenization process. Some embodiments of the disclosure may further create a coating of up to about 500 μm in thickness after all layers have been subjected to a homogenization process. Some embodiments of the disclosure may further create a coating of about 500 μm in thickness or thicker after all layers have been subjected to a homogenization process.

Some embodiments of the disclosure can further create a single coating after homogenization which may be comprised of 15-25% Cr, 4-8% Al, and 0.01-0.1% Y weight percent. The remaining balance of the coating may be comprised of Ni. Some embodiments of the disclosure can further create a single coating after homogenization which may be comprised of 20-30% Cr, 3-6% Al, and 0.01-0.1% Y weight percent. The remaining balance of the coating may be comprised of Ni.

Some embodiments of the disclosure may further have the first nickel layer applied to the superalloy substrate by electroplating. Some embodiments of the disclosure may further have the second nickel layer applied to the first segment using electroplating,

Some embodiments of the disclosure may further subject one or more coated turbine blades to a temperature regime of about 950° C. or higher. Some embodiments of the disclosure may further subject one or more coated turbine blades to the service for a temperature regime of about 800-950° C.

Some embodiments of the disclosure provide a method for coating one or more components of a gas turbine, Components include any combination of blades, vanes, or combustion chambers. These components may be a superalloy substrate. The coating can be adhered to the component by first applying a segment which can be comprised of an amount of Ni, and an amount of Cr. The second segment can be comprised of an amount of Ni, and an amount of Cr. Additional segments can be added until a desired thickness of total segments is achieved. Once the desired thickness is achieved, the segments may be subjected to a homogenization treatment, The homogenization treatment can create a single coating on the superalloy substrate of uniform concentrations of the elements contained. in the segments adhered to the superalloy substrate.

Some embodiments of the disclosure may further subject one or more coated turbine components to the service for a temperature regime of about 600-800° C. Some embodiments of the disclosure can further create a single coating after homogenization which may be comprised of 30-45% Cr. The remaining balance of the coating may be comprised of Ni.

Some embodiments of the disclosure may further create a coating of about 300-500 μm in thickness after all layers have been subjected to a homogenization process. Some embodiments of the disclosure may further create a coating of up to about 500 μm in thickness after all layers have been subjected to a homogenization process. Some embodiments of the disclosure may further create a coating about 500 μm in thickness or thicker after all layers have been subjected to a homogenization process

### BRIEF DESCRIPTION OF THE DRAWINGS

FIG. 1 is a side plane view illustrating one embodiment of four alternating segments, each segment comprised of a nickel layer and a diffusion layer, where the segments have been applied to a superalloy substrate prior to the homogenization treatment.

FIG. 2 is a side plane view illustrating one embodiment of a coating created by the segments of nickel layer and diffusion layer, as well as the superalloy substrate, after the homogenization treatment.

### DETAILED DESCRIPTION

Disclosed herein are methods and compositions for protecting superalloy substrates of gas turbine componentry, particularly the blades, vanes, and combustion chambers of the gas turbine. The disclosure relates to the coatings of nickel-base austenitic alloys exhibiting excellent ductility and toughness, such that the coatings are particularly suitable for gas turbine components, such as gas turbine blades and vanes, which are exposed to high-temperature corrosive environments under cyclic stresses.

A gas turbine consists of three major sections: the compressor, the combustor, and the turbine section. In operation, the compressor takes air in, and compresses the air to high pressures. The compressed air is then mixed with fuel in the combustor for combustion to generate high-velocity, hot-combustion gas. This hot-combustion gas is expanded in the turbine section, and passed through a series of turbine vanes, which direct and accelerate the gas into the turbine blades. As the mass of the high velocity gas flows across the turbine blades, the gaseous energy is converted to mechanical energy as the turbine blades rotate due to the force from the gas.

The turbine section of the gas turbine typically contains a number of stages of turbine blades and vanes. These stages of the turbine section can be physically separate from one another, or can be distinguished based on operational or functional characteristics. As the hot combustion gas stream enters into the turbine section, the first stage blades and vanes experience the hottest metal temperature. As the combustion gas stream flows through the subsequent stages of turbine blades and vanes, the temperature of the combustion gas cools, and the blades and vanes in the subsequent stages likewise operate at a cooler temperature. Accordingly, turbine blades and vanes are subjected to a range of temperatures depending on their locations within the turbine section. Variables determining the temperature regime experienced by the turbine blade or vane include length, make, and type of gas turbine.

Because of the wide temperature variation which can exist in a single turbine, at least three types of high temperature corrosion can occur, resulting in degradation to the components, such as the blades and vanes. At metal temperatures above approximately 950° C., the turbine blades and vanes are prone to oxidation or oxidative attack of the coating and superalloy substrate. At metal temperatures of approximately 800-950° C., the turbine blades and vanes are prone to corrosive attack via molten salt induced Type I hot corrosion. And, at metal temperatures of approximately 600-800° C., the turbine blades and vanes are prone to corrosive attack via molten salt induced Type II hot corrosion. Hot corrosion by both Type I and Type II is the result of accelerated sulfidation due to the formation of molten sulfate salts (e.g., Na₂SO₄ in Type I hot corrosion, Ni₂SO₄—CoSO₄ or CoSO₄-NiSO₄ for Type II hot corrosion) resulting from the combustion between fuel which contains impurities (e.g., sulfur) and air containing sea salt (NaCl). Because the temperature of combustion gas cools as it travels through the turbine, blades closest to the start of the turbine, nearest the combustor, are more likely to experience oxidation, while blades located towards the end of the combustion gas flow are more likely to experience Type II hot corrosion. Blades located more centrally in the combustion gas flow can suffer from both oxidation and Type I hot corrosion, depending on the heat fluctuations occurring in the turbine. For marine gas turbines which operate in marine environments, such as naval aircrafts, naval ships and vessels, and onshore and offshore facilities, hot corrosion attack can be more severe due to the higher quantity of salt deposits formed as a result of the air containing higher levels of sea salt that is ingested into the gas turbine for combustion.

Coatings are used to protect turbine blades and vanes from oxidation, Type I hot corrosion, and Type II hot corrosion. These protective coatings can be produced through several different methods. One method used to create coatings is electron beam physical vapor deposition. However, electron beam physical vapor deposition can be costly. As a result, most coatings are produced through pack cementation, either in-the-pack or out-of-the pack. Pack cementation is used as a relatively inexpensive process, in comparison to electron beam physical vapor deposition.

Nickel aluminide diffusion coatings produced by pack cementation are commonly used to resist oxidation attack. These nickel aluminide diffusion coatings based on β phase NiAl intermetallic compound tend to have high concentrations of aluminum, and are very thin because conventional pack cementation does not allow for customization of coating thickness. Coating thicknesses greater than 125 μm are not readily obtainable. When the nickel aluminide diffusion coatings are exposed to high temperatures, the coating forms an Al₂O₃ (aluminum oxide) scale, The Al₂O₃ scale grows with increased use of the gas turbine, causing the coating to lose the aluminum content over time. Eventually, this decrease in the amount of aluminum present in the coating causes the level of aluminum to fall below the amount necessary to maintain the protective Al₂O₃ scale.

Additionally, the high levels of Al present in current nickel aluminide diffusion coatings can reduce ductility and toughness, both in the superalloy substrate and in the coating. Some of the Al content is reduced or lost by diffusion of Al from the coating to the substrate alloy, which can reduce the ductility of the substrate, rendering the substrate more susceptible to cracking under cyclic stresses. Further, the high concentration of Al in a thin coating can make the coatings extremely brittle, rendering the coatings susceptible to cracking under cyclic stresses. A crack in the coating can penetrate into the substrate superalloy, leading to premature fracturing.

The role of the coating is to form and maintain the protective oxide scale. The oxide scale grows slowly over time after first forming. The oxide scale must be able to reform should some of it become damaged due to cracking or imperfections. The coating aids in reforming the oxide scale by acting as a reservoir of the oxide forming elements, primarily aluminum and chromium, which form the Al₂O₃ or Cr₂O₃ scales, respectively. As discussed above, the nickel aluminide coatings known previously in the art were very thin (on the order of 100 μm or less) and may also be subjected to martensitic phase transformation, which produces volume changes and results in additional internal stresses for these intrinsic brittle coatings.

The disclosure provided herein relates to methods of producing and using ductile nickel-based austenitic alloy coatings with a lower Al concentration. Whereas the coatings used previously were thin and contained high concentrations of aluminum, the present disclosure and methods for applying the coatings provides for lower Al concentration within a thicker overall coating. The lower Al concentration allows the coating to retain its ductility and remain in an austenitic state; high concentrations of Al can form a coating based on a brittle phase, and are thereby more susceptible to cracking. Further, by making the coatings austenitic, the coatings retain a face centered cubic lattice at all temperatures. This face centered cubic lattice arrangement allows the coatings to exhibit ductibility at the high temperatures existing in turbines without sacrificing durability, as austinetic alloys are known both for toughness and resistance to corrosion. By increasing the ductility of the coating, the likelihood of premature fracturing of the substrate due to cyclic stress is reduced, potentially extending the useful life of the turbine blades.

Further, the disclosed methods for producing ductile nickel-based austenitic alloy coatings allow the coatings to be customized to a desired level of thickness. By creating a thicker coating, more Al is available to create a protective scale against oxidization and hot corrosion, without significantly reducing the ductility of the substrate superalloy or coating, since the overall concentration of Al is lower.

In order to maximize the utility and longevity of the blades, vanes, and combustion chambers, the coating must be capable of forming a protective oxide scale or barrier. The oxide scale may be Al₂O₃ or Cr₂O₃ and provide protection against the high-temperature corrosion that the substrate superalloy blade is most likely to experience: oxidation, Type I hot corrosion, or Type II hot corrosion.

By using the disclosed methods, a coating may be selected based on the temperature regime the blade experiences, with the temperature regime corresponding directly to the three forms of high temperature corrosion. By coating turbine blades with a coating designed to protect against the high temperature corrosion the blade will experience, the useful life of the turbine as a whole can be extended. Thus, the disclosed invention protects the entire turbine, from the early stage blades, to the last stage blades.

One embodiment is comprised of a gas turbine containing a plurality of turbine blades, generally arranged in a series of stages. First stage blades, those positioned closest to the combustor, experience the highest temperature regime, approximately 950° C. or above. The first stage may also contain a plurality of vanes to direct the gas flow to the blades. Blades in the first stage are particularly susceptible to oxidation due to the high temperature exposure. To prevent the blades from experiencing oxidation attack, the blades are protected by a coating comprised of the elements Ni, Cr, Al, and Y. The methods and coatings disclosed herein allow for significantly reduced Al content in the coating, on the order of approximately 8% w/w or less. It is contemplated that the Al content may be, for example, approximately 8% w/w of the coating; approximately 7% w/w of the coating; may be approximately 6% w/w of the coating; may be approximately 5% w/w of the coating; may be approximately 4% w/w of the coating; may be approximately 3% w/w of the coating; may be approximately 2% w/w of the coating; or may be approximately 1% w/w of the coating.

In one non-limiting embodiment, the coating for the first stage blades may comprise approximately 15%-25% Cr, 4-8% Al, and 0.01-0.1% Y, weight percent, the remaining balance comprised of Ni. It is contemplated that the ranges of the other elements may be adjusted to accommodate the appropriate level of Al desired in the coating. When the blades are subjected to the high temperature regime, the coating forms an Al₂O₃ oxide scale, protecting against oxidation.

A second stage of blades positioned further away from the combustor and downstream of the first stage experience a midlevel temperature regime, approximately 800-950° C. Blades in the second stage are susceptible to oxidation and Type I hot corrosion. To prevent the blades from experiencing oxidation attack, or Type I hot corrosion, the blades are protected by a coating comprised of the elements Ni, Cr, Al, and Y. The methods and coatings disclosed herein allow for significantly reduced Al content in the coating, on the order of approximately 6% w/w or less. It is contemplated that the Al content may be, for example, approximately 6% w/w of the coating; may be approximately 5% w/w of the coating; may be approximately 4% w/w of the coating; may be approximately 3% w/w of the coating; may be approximately 2% w/w of the coating; or may be approximately 1% w/w of the coating.

In one non-limiting embodiment, the coating for the second stage blades may comprise approximately 20-30% Cr, 3-6% Al, and 0.01-0.1% Y weight per cent, the remaining balance Ni. It is contemplated that the ranges of the other elements may be adjusted to accommodate the appropriate level of Al desired in the coating. When the blades are subjected to the temperature regime of approximately 800-950° C., the coating forms a Cr₂O₃-Al₂O₃ oxide scale, protecting against both oxidation and Type I hot corrosion.

A third stage of blades positioned downstream of the second stage experience a lower temperature regime, of approximately 600-800° C. Blades in the third stage of the turbine are most susceptible to Type II hot corrosion. To prevent the blades from experiencing Type II hot corrosion, the blades are protected by a coating comprised of approximately 30-45% Cr, weight percent, the remaining balance Ni. When exposed to the applicable temperature regime, the coating forms a Cr₂O₃ scale protecting the blade from Type II hot corrosion.

The blade and vane coatings for each stage may be formed by a process of segmentation, wherein multiple segments are applied to the blade sequentially to form an overall coating on the blade or vane. Applying multiple segments in this manner allows for a greater total thickness of the coating than previously available. In turn, this greater coating thickness allows for reduced concentrations of aluminum in the coating, while maintaining or increasing the overall amount of aluminum available for formation and the maintenance of the protective oxide scale during operation of the turbine.

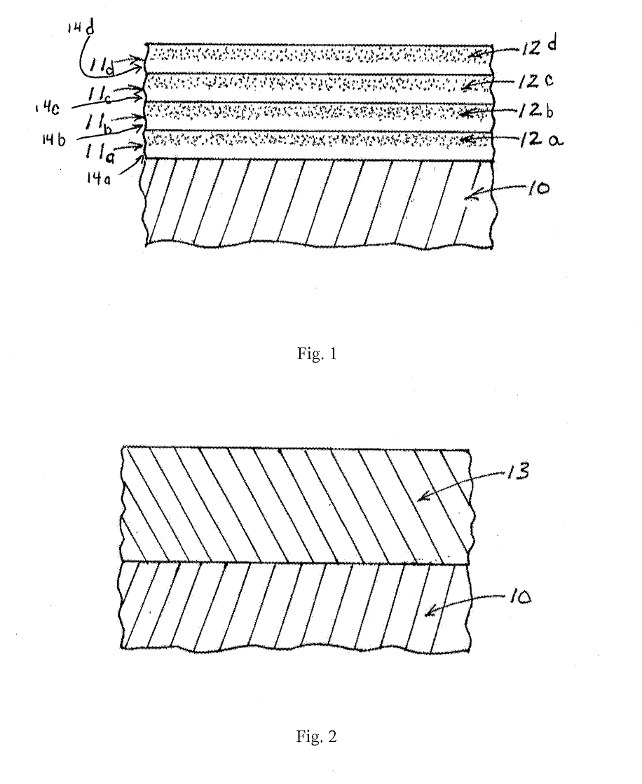

FIG. 1 and FIG. 2 illustrate embodiments of a method for creating a protective coating for a superalloy substrate. FIG. 1 is a schematic view of the cross-section of the coating applied to the blades, prior to homogenization of the segments. FIG. 2 is a schematic of the cross-section of the coating following homogenization of the segments. Below, FIG. 1 and FIG. 2 will be discussed in the context of forming blade and vane coatings for the three stages of the turbine section of a gas turbine.

Generally, FIG. 1 shows the application of multiple segments to a superalloy substrate 10 of a turbine component (e.g., blade or vane). A segment 14 can be considered one nickel layer 11 and one diffusion layer 12 together, as seen in FIG. 1.

Regarding FIG. 1, in one example, the superalloy substrate 10 is used in the first stage of the gas turbine section located nearest to the combustor. A nickel layer 11a is applied to the substrate 10 using, for example, electroplating. Thereafter, the nickel layer 11a and substrate 10 then undergo a process of pack cementation (e.g., chromizing and/or aluminizing) with optional co-deposition of yttrium, producing a diffusion layer 12a enriched in Cr, Al, and. Y within the nickel layer 11a as well as on the surface of the nickel layer 11a. The pack cementation process involves applying a diffusion layer of Cr, Al, and Y over the nickel layer. In this manner, a first segment 14a comprised of the nickel layer and diffusion layer is formed on the substrate 10. As part of the pack cementation process of applying the diffusion layer at approximately 850-1150° C., the resulting first segment 14a can be produced with a thickness of approximately 100-150 μm.

The process is then repeated by applying a second segment 14b to the first segment 14a. Applying the second segment involves first applying a second nickel layer 11b to the first segment 14a, using, for example, electroplating. Thereafter, the second nickel layer 11b and the first segment 14a and substrate 10 undergo a process of pack cementation (e.g., chromizing and/or aluminizing) with co-deposition of yttrium, producing a diffusion layer 12b enriched in Cr, Al, and Y, within nickel layer 11b as well as on the surface of nickel layer 11b. The pack cementation process involves applying a diffusion layer of Cr, Al, and Y over the nickel layer. In this manner, a second segment 14b is formed on the first segment 14a, As part of the pack cementation process of applying the diffusion layer at approximately 850-1150° C., the second segment 14b can be produced with a thickness of approximately 100-150 μm.

The process is then repeated to produce additional segments, for example segments 14c and 14d shown in FIG. 1, by applying a nickel layer 11 containing a diffusion layer 12 enriched in Cr, Al, and Y. If a thicker coating is required, more segments can be added in the process. It is contemplated that the segmentation process may be performed between two and six times to attain the desired thickness of the coating, up to approximately 600 μm.

Once the desired thickness is achieved, the coating in FIG. 1 undergoes a homogenization treatment to produce a homogenized coating 13 shown in FIG. 2. The homogenization treatment involves heating the segmented coating at approximately 1000° C.-1200° C. in an inert environment, Upon homogenization, the coating 13 contains a uniform distribution of Ni, Cr, Al, and Y throughout the coating. In certain embodiments, the homogenized coating contains 15-25% Cr, 4-8% Al, 0.1-0,01% Y, weight per cent, the remaining balance Ni. Due to the relatively low concentration of Al in the coating, in one embodiment, the coating is built to thickness of approximately 600 μm in order to provide the necessary amount of Al for the Al₂O₃ oxide scale. The selected thickness and low Al concentration allows the coating 13 to form a protective Al₂O₃ oxide scale over an extended period of time when exposed to a temperature regime of 950° C. or above, while still retaining ductility.

In another example, the superalloy substrate 10 exists for use in the second stage of the gas turbine section, downstream of the first stage in the gas turbine. The segmentation process described above with relation to the first stage coatings can be applied also to the second stage coatings. It is contemplated that the segmentation process may be performed between two and six times to attain the desired thickness of the coating, up to approximately 600 μm.

As with the first stage, once the desired coating thickness is achieved via the segmentation process, the coating in FIG. 1 undergoes a homogenization treatment to produce a homogenized coating 13 shown in FIG. 2, with a uniform concentration of Ni, Cr, Al, and Y. The homogenization treatment involves heating the segmented coating at approximately 1000° C.-1200° C. in an inert environment. In certain embodiments of the second stage, the homogenized coating contains 20-30% Cr, 3-6% Al, 0.01-0.1% Y, and the remaining balance Ni, all weight percent, Due to the relatively low concentration of Al in the coating, one preferred embodiment of the coating is built to a thickness of approximately 600 μm in order to provide the necessary amount of Al for the oxide barrier. The selected thickness and low concentration of Al allows the coating to form a protective mixed Cr₂O₃-Al₂O₃ oxide scale over an extended period of time when exposed to a temperature regime of approximately 800-950° C.

In a third example, the substrate superalloy component 10 exists for use in the third stage of the gas turbine section, downstream of the second stage. The segmentation process described above with relation to the first stage coatings can be applied also to the third stage coatings. It is contemplated that the segmentation process may be performed between two and six times to attain the desired thickness of the coating, up to approximately 600 μm.

For the third stage segmentation process, a nickel layer 11 is applied to the substrate superalloy component 10 using electroplating. The substrate superalloy component 10 and nickel layer 11 then undergo chromizing to produce a diffusion layer 12 enriched in Cr within nickel layer 11 as well as on the surface of nickel layer 11. The process is repeated, for example three additional times to produce a second, third, and fourth layer of nickel layer 11 containing a diffusion layer 12 enriched in Cr. Once the desired thickness is achieved, the segmented coating in FIG. 1 undergoes a homogenization treatment to produce a coating 13 of FIG. 2, with a uniform concentration in Cr in the Ni. In certain embodiments, the homogenized coating is comprised of 30-45% Cr, weight percent, and the remaining balance Ni.

Conditional language such as, among others, “can,” “could,” “might” or “may,” unless specifically stated otherwise, are otherwise understood within the context as used in general to convey that certain embodiments include, while other embodiments do not include, certain features, elements and/or operations. Thus, such conditional language is not generally intended to imply that features, elements and/or operations are in any way required for one or more embodiments or that one or more embodiments necessarily include logic for deciding, with or without user input or prompting, whether these features, elements and/or operations are included or are to be performed in any particular embodiment.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A gas turbine comprising:
a combustor containing combustion chambers with a coating comprised of approximately 15-25% Cr, 4-8% Al, 0.01-0.1% Y weight percent, and the remaining balance Ni;
a turbine section comprised of at least three stages, each stage comprised of a plurality of turbine components, including blades or vanes, or blades and vanes;
a first stage located nearest to the combustor, wherein the first stage turbine components each comprise a superalloy substrate and a coating on the substrate comprised of approximately 15-25% Cr, 4-8% Al, 0.01-0.1% Y weight percent, and the remaining balance Ni;
a second stage located downstream of the first stage, wherein the second stage turbine components comprise a superalloy substrate and a coating on the substrate comprised of approximately 20-30% Cr, 3-6% Al, 0.01-0.1% Y weight percent and the remaining balance Ni; and
a third stage located downstream of the second stage, wherein the third stage turbine components comprise a superalloy substrate and a coating on the substrate comprised of approximately 30-45% Cr, weight percent, and the remaining balance Ni.

2. The gas turbine of claim 1 wherein the first stage turbine components are subjected to temperature regime of about 950° C. or higher.

3. The gas turbine of claim 1, wherein the second stage turbine components are subjected to a temperature regime of about 800-950° C.

4. The gas turbine of claim 1, wherein the third stage turbine components are subjected to a temperature regime of about 600-800° C.

5. The gas turbine of claim 1, wherein the coating on at least one turbine component in each stage is about 300-500 μm in thickness or thicker.

6. A method of coating a gas turbine component comprised of a superalloy substrate, including a blade, a vane, or a combustion chamber, the method comprising:
applying a first segment to the superalloy substrate, the first segment is comprised of at least an amount of Ni, an amount of Cr, an amount of Al and an amount of Y;
applying a second segment on top of the first segment, the second segment comprised of at least an amount of Ni, an amount of Cr, an amount of Al, and an amount of Y;
repeating application of additional segments until a desired thickness of total segments is achieved; and
subjecting all segments to a homogenization treatment to produce a single coating on the superalloy substrate with uniform concentrations of the elements contained in the segments.

7. The method of claim 6, wherein the step of applying a first segment to the superalloy comprises:
applying the Ni to the superalloy substrate as a first nickel layer; and
applying the Cr, Al, and Y to the first nickel layer as a first diffusion layer generated at a temperature of at least 850° C. to form the first segment on the superalloy substrate.

8. The method of claim 7, wherein the step of applying a second segment comprises:
applying the Ni to the first segment as a second nickel layer; and
applying the Cr, Al, and Y to the second nickel layer as a second diffusion layer generated at a temperature of at least 850° C. to form the second segment on the first segment.

9. The method of claim 8, wherein additional steps comprise:
repeating application of additional segments until a desired thickness of total segments is achieved; and
subjecting all segments to a homogenization treatment to produce a single coating on the superalloy substrate with uniform concentrations of the elements contained in the segments.

10. The method of claim 6, wherein the first segment or the second segment is about 100 μm in thickness,

11. The method of claim 6, wherein the single coating produced by homogenization is about 300-500 μm in thickness.

12. The method of claim 6, wherein the single coating produced by homogenization is up to about 500 μm in thickness.

13. The method of claim 6, wherein the single coating produced by homogenization is about 500 μm in thickness or thicker.

14. The method of claim 6, wherein the single coating produced by homogenization is comprised of 15-25% Cr, 4-8% Al, 0.01-0.1% Y weight per cent, and the remaining balance Ni.

15. The method of claim 6, wherein the single coating produced by homogenization is comprised of 20-30% Cr, 3-6% Al, 0.01-0.1% Y weight per cent, and the remaining balance Ni.

16. The method of claim 7, wherein the first nickel layer is applied to the superalloy substrate by electroplating.

17. The method of claim 6, wherein the coated component is subjected to a temperature regime of about 950° C. or higher.

18. The method of claim 6, wherein the coated component is subjected to a temperature regime of about 800-950° C.

19. A method of coating a gas turbine component comprised of a superalloy substrate, including a blade, a vane, or a combustion chamber, the method comprising:
applying a first segment to the superalloy substrate, the first segment is comprised of at least an amount of Ni, and an amount of Cr;
applying a second segment on top of the first segment, the second segment comprised of at least an amount of Ni, and an amount of Cr;
repeating application of additional segments until a desired thickness of total segments is achieved; and
subjecting all segments to a homogenization treatment to produce a single coating on the superalloy substrate with uniform concentrations of the elements contained in the segments.

20. The method of claim 19, wherein the step of applying a first segment to the superalloy comprises:
applying the Ni to the superalloy substrate as a first nickel layer; and
applying the Cr to the first nickel layer as a first diffusion layer generated at a temperature of at least 850° C. to form the first segment on the superalloy substrate.

21. The method of claim 20, wherein the step of applying a second, segment comprises:
applying the Ni to the first segment as a second nickel layer; and
applying the Cr to the second nickel layer as a second diffusion layer generated at a temperature of at least 850° C. to form the second segment on the first segment.

22. The method of claim 21, wherein additional steps comprise:
repeating application of additional segments until a desired thickness of total segments is achieved; and
subjecting all segments to a homogenization treatment to produce a single coating on the superalloy substrate with uniform concentrations of the elements contained in the segments.

23. The method of claim 19, wherein the coated gas turbine blade is subjected to a temperature regime of about 600-800° C.

24. The method of claim 19, wherein the single coating produced by homogenization is comprised of 30-45% Cr, weight per cent, and the remaining balance Ni.

25. The method of claim 19, wherein the single coating produced by homogenization is about 300-500 μm in thickness.

26. The method of claim 19, wherein the single coating produced by homogenization is up to about 500 μm in thickness.

27. The method of claim 19, wherein the single coating produced by homogenization is about 500 μm in thickness or thicker.
